(19) United States
(12) Patent Application Publication
(10) Pub. No.: US 2025/0135790 A1
(43) Pub. Date: May 1, 2025

(54) SYSTEMS AND METHODS OF PRINTING ON A FLEXIBLE SUBSTRATE

(71) Applicant: Cryovac, LLC, Charlotte, NC (US)

(72) Inventors: Theodore F. Cyman, Grand Island, NY (US); Anthony Vincent Moscato, N. Tonawanda, NY (US); Frank J. Rocco, N. Tonawanda, NY (US)

(21) Appl. No.: 18/722,733

(22) PCT Filed: Dec. 22, 2022
(86) PCT No.: PCT/US2022/053763

§ 371 Date: Jun. 21, 2024

Related U.S. Application Data
(60) Provisional application No. 63/293,196, filed on Dec. 23, 2021.

(51) Int. Cl. B41J 11/00; B41J 3/407; B41J 3/60; B41J 11/46

(52) U.S. Cl. CPC B41J 11/0095; B41J 3/407; B41J 3/60; B41J 11/002; B41J 11/46; B41J 2203/011

(57) ABSTRACT

Printing systems and methods of printing using at least first and second printing units (100a, 100b) to print on a flexible substrate (22) sense distortion of the substrate during printing and adjust the effective resolution of the second printing unit (100b) to achieve registration at least to a desired degree.

### CROSS REFERENCE TO RELATED APPLICATION

The present application claims the benefit of U.S. Provisional Patent Application Ser. No. 63/293,196, filed on Dec. 23, 2021, and entitled “SYSTEMS AND METHODS OF PRINTING ON A FLEXIBLE SUBSTRATE.” The entire contents of this application are incorporated herein by reference.

### FIELD OF DISCLOSURE

The present subject matter disclosed herein relates to printing systems and methods, and more particularly, to a printing system and method using at least first and second printing units to print on a flexible substrate that compensates for distortion in the web so that misregistration errors are minimized.

### BACKGROUND

High speed printing systems have been developed for printing on a substrate, such as a web of heat shrinkable polymeric film. Such a material typically exhibits both elasticity and plasticity characteristics that depend upon one or more applied influences, such as force, heat, chemicals, electromagnetic radiation, etc. These characteristics must be carefully taken into account during the system design process because it may be necessary: 1.) to control material shrinkage during imaging so that the resulting imaged film may be subsequently used in a shrink-wrap process, and 2.) to avoid system control problems by minimizing dynamic interactions between system components due to the elastic deformability of the substrate. Such considerations also impact the process of registering printed content so that the content is accurately reproduced.

Specifically, a flexible web may be printed simplex (i.e., on one side) or duplex (that is, two sided). In either event, separately printed images, even if printed by a single printing unit (e.g., a multi-color imager unit), must be accurately registered with one another to minimize misregistration errors, such as color shifts, moire, undesired dot gain effects, or the like.

Furthermore, the use of water-based inks for commercial print applications, including but not limited to ink jet printing, has been on the increase due in part to environmental and health concerns about volatile organic compounds (“VOC's”) in solvent-based compositions that are emitted during the drying process.

As for general printing on a substrate or web that is porous or permeable, water within the ink is partially absorbed by the surface of the web during a drying process. However, there exists a problem when water-based inks are deposited on a web that is impermeable, such as a plastic web. Since inks dry primarily via evaporation during a drying and/or curing period, the lack of ability of the water-based ink to penetrate or absorb into the web itself leads to individual ink droplets spreading across the surface of the web. If a compilation of individual ink droplets spread and touch one another, the desired image quality may be adversely affected due to coalescing of the adjacent ink droplets. This is a problem that typically occurs with high-speed printing and is addressed by carefully drying the printed web. Such drying, however, can lead to a distortion of the web. Typically, distortion is reversible in the sense that the web returns substantially or completely to its undeformed state when processing is complete. However, failure to take these effects into account during printing can lead to misregistration errors, color shifts, and other defects in the printed product.

Still further in order to achieve the desired properties such as proper adhesion and rub resistance in current systems, multiple layers of inks and coatings may be necessary. For instance, a primer layer may be placed upon a web prior to an ink layer being deposited in the same location as the primer layer. Furthermore, an overprint varnish or coating may be placed upon the ink layer to achieve the proper rub resistance. In any event, registration between ink layers must be maintained to ensure production of quality product.

The discussion above is merely provided for general background information and is not intended to be used as an aid in determining the scope of the claimed subject matter.

### SUMMARY

According to one aspect, a printing system for printing on a flexible substrate movable in a downstream process direction comprises a first ink jet printing unit that prints on the substrate a first plurality of spaced registration marks, a second plurality of raster lines between a first successive pair of registration marks, and a third plurality of raster lines between a second successive pair of registration marks that are adjacent the first pair of successive registration marks wherein the first plurality of raster lines and the second plurality of raster lines together comprise a single image. The system further comprises a detector downstream of the first printing unit that detects the first successive pair of registration marks, calculates a first magnitude of distortion of the substrate based on the detection of the first successive pair of registration marks, detects the second successive pair of registration marks, and calculates a second magnitude of distortion of the substrate based on the detection of the second successive pair of registration marks. A second ink jet printing unit is responsive to and downstream of the detector that prints on the substrate a fourth plurality of raster lines between the first successive pair of registration marks at positions relative to the second plurality of raster lines dependent upon the first magnitude of distortion. The second ink jet printing unit further prints a fifth plurality of raster lines between the second successive pair of registration marks at positions relative to the third plurality of raster lines dependent upon the second magnitude of distortion.

According to another aspect, a method of ink jet printing on a flexible substrate movable in a downstream process direction comprises the step of undertaking a first printing process on the substrate at a first print process position to print a first plurality of spaced registration marks, a second plurality of raster lines between a first successive pair of registration marks, and a third plurality of raster lines between a second successive pair of registration marks that are adjacent the first pair of successive registration marks wherein the first plurality of raster lines and the second plurality of raster lines together comprise a single image. The method further comprises the steps of detecting the first successive pair of registration marks, calculating a first magnitude of distortion of the substrate based on the detection of the first successive pair of registration marks, detecting the second successive pair of registration marks, and calculating a second magnitude of distortion of the substrate based on the detection of the second successive pair of registration marks. The method still further comprises the steps of undertaking a second printing process on the substrate at a second print process position downstream of the first print process position to print a fourth plurality of raster lines between the first successive pair of registration marks at positions relative to the second plurality of raster lines dependent upon the first magnitude of distortion and undertaking a third printing process on the substrate to print a fifth plurality of raster lines between the second successive pair of registration marks at positions relative to the third plurality of raster lines dependent upon the second magnitude of distortion.

According to yet another aspect, a printing system for printing on a flexible substrate movable in a downstream process direction comprises a first ink jet printing module that prints a first material on the substrate, and a second ink jet printing module stacked atop the first module that prints a second material on the substrate. Further, a controller is operable to cause the first and second ink jet modules to print in a coordinated fashion.

Other aspects and advantages will become apparent upon consideration of the following detailed description and the attached drawings wherein like numerals designate like structures throughout the specification.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an isometric view with portions removed therefrom of an embodiment of a module for printing one or more aqueous substances on a flexible substrate;

FIG. 2 is an isometric view with portions removed therefrom of a printing system utilizing two of the modules of the embodiment of FIG. 1 in a stacked configuration;

FIG. 3 is a side elevational block diagram of the embodiment of FIG. 2 configured in an arrangement for duplex printing;

FIG. 4 is an enlarged isometric view with portions removed therefrom of the system of FIG. 2;

FIG. 5 is a front elevational view of the system of FIG. 2 as illustrated in FIG. 4;

FIG. 6 is a fragmentary, enlarged, isometric view of a portion of the system of FIG. 2;

FIGS. 7, 8, and 9 are various isometric views with portions omitted therefrom of an embodiment of a module for printing one or more substances on a flexible substrate;

FIG. 10 is an enlarged, fragmentary, isometric view of the embodiment shown in FIG. 7;

FIG. 11 is a sectional view taken generally along the lines 11-11 of FIG. 7;

FIG. 12 is a sectional view taken generally along the lines 12-12 of FIG. 7;

FIG. 13 is a side elevational view with portions omitted therefrom of two of the modules of FIG. 7;

FIG. 14 is a side elevational view schematically illustrating a portion of a print system that may utilize any printing equipment, such as one or more of the embodiments of modules for printing one or more aqueous substances on a flexible substrate disclosed herein;

FIG. 15 is a fragmentary plan view of the substrate of FIG. 14 after printing by the first print unit;

FIG. 16 is a block diagram of a global controller in conjunction with various devices of a print system including a main ink reservoir, and ink supply system, a printing unit and a dryer and interconnections therebetween;

FIG. 17 is a block diagram of portions of the global controller of FIGS. 14 and 16;

FIG. 18 is a block diagram of the registration module of FIG. 17 in conjunction with devices illustrated in FIG. 14;

FIG. 19 is a simplified flowchart illustrating a portion of software executed by the SPM of FIG. 18; and

FIG. 20 is a simplified flowchart illustrating a portion of software executed by the synthesizer of FIG. 18.

### DETAILED DESCRIPTION

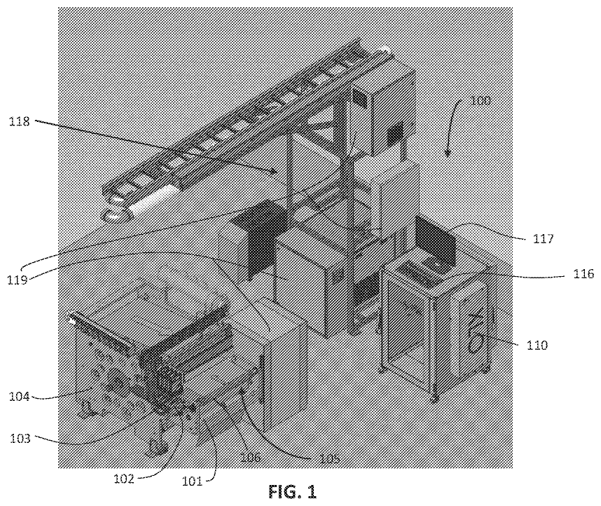

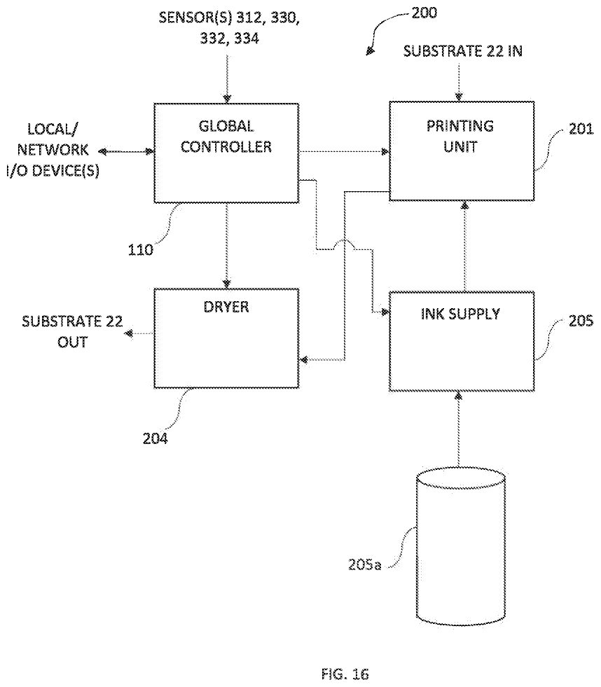

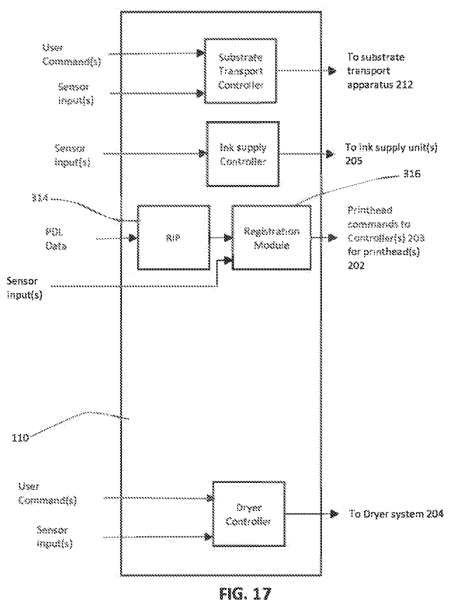

A flexible substrate 22 in the form of a web, of, e.g., thermoplastic polymer material, is passed through one or more printing modules and receives ink, which is dried to obtain a printed web that may be further processed to form printed individual units, such as bags. The bags may be adapted to receive one or more articles therein. More particularly, FIG. 1 illustrates an embodiment in which a module 100 includes one or more printing units 101 each comprising one or more printheads 102 with associated printhead controllers 103 and one or more ink supplies (not shown), a dryer system 104 comprising one or more dryers, and infeed/outfeed handling apparatus 105 comprising one or more infeed and outfeed rollers 106. As seen in FIGS. 16 and 17 in connection with an embodiment described hereinafter, a global or supervisory controller 110 controls the operation of the printheads 102, the dryer system 104, and the infeed/outfeed handling apparatus 105, wherein the handling apparatus comprises a portion of a substrate transport apparatus 112 that controls the continuous movement of the substrate 22 at a throughput speed of, for example, between about 100 feet per minute and about 500 feet per minute, or for example, between about 200 feet minute and about 500 feet per minute, or for example, above about 500 feet per minute.

In an embodiment, the web is a film such as a flexible polymeric film. As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

In an embodiment, the film is a multi-layer film. Multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

In embodiments, the multilayer film has a free shrink of at least 10%, 20%, 30%, 40% and 50% at 85° C. measured in accordance with ASTM D2732. As used herein, the phrase “free shrink” refers to the percent dimensional change in a 10 cm×10 cm specimen of film, when shrunk at 185° F., with the quantitative determination being carried out according to ASTM D2732 “Standard Test Method for Unrestrained Linear Thermal Shrinkage of Plastic Film and Sheeting.” Unless otherwise indicated, all free shrink values disclosed herein are, of course, “total” free shrink values, which represent a sum of (a) the percent free shrink in the longitudinal (i.e., “machine”) direction dimension and (b) the percent free shrink in transverse direction.

With reference again to FIG. 1, the global controller 110 further controls an ink supply apparatus (not shown), a printhead transport apparatus 114 and a printhead cleaning apparatus 115. The global controller 110 may be implemented by one or more suitably programmed computer-based devices. The global controller 110 is coupled to local and/or networked interfaces, such as a keyboard 116, a mouse, a display 117, a touchscreen, a local area network (LAN), a wide area network (WAN) such as the Internet, etc. The global controller 110 is responsive to commands supplied thereto by a user.

Referring again to FIG. 1, one or more structural elements 118 provide support for various conduits and other elements and enclosures 119 provide spaces to house various elements, as necessary and/or desirable.

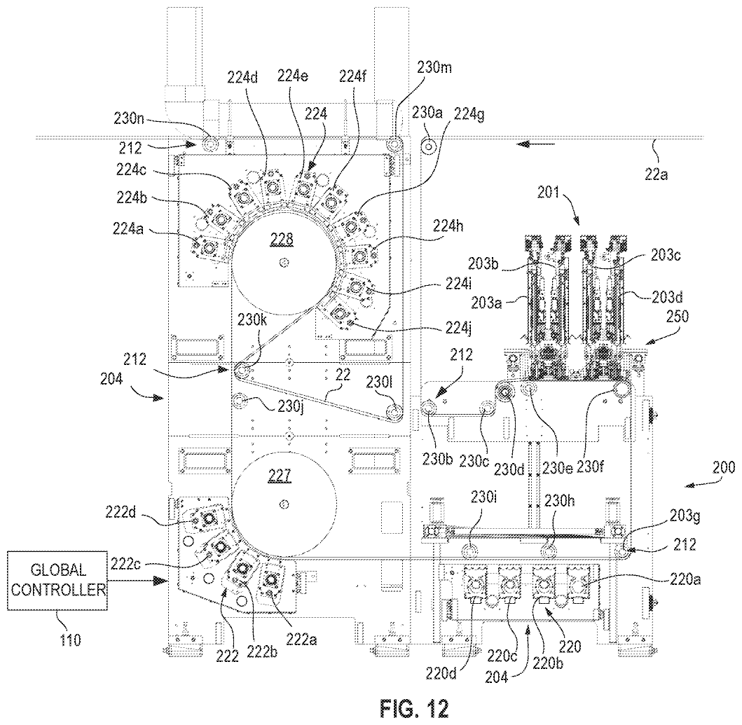

The embodiment of FIG. 1 may be operated in a simplex mode to print on a side of a flexible substrate. In a preferred form, and as in other embodiments disclosed herein, the embodiment of FIG. 12 prints up to four colors on a side of a flexible substrate using cyan, magenta, yellow, and/or black primary process colors (C, M, Y, and/or K). If more colors are to be printed, additional printheads and associated printhead controllers and ink supplies can be added to the module 100.

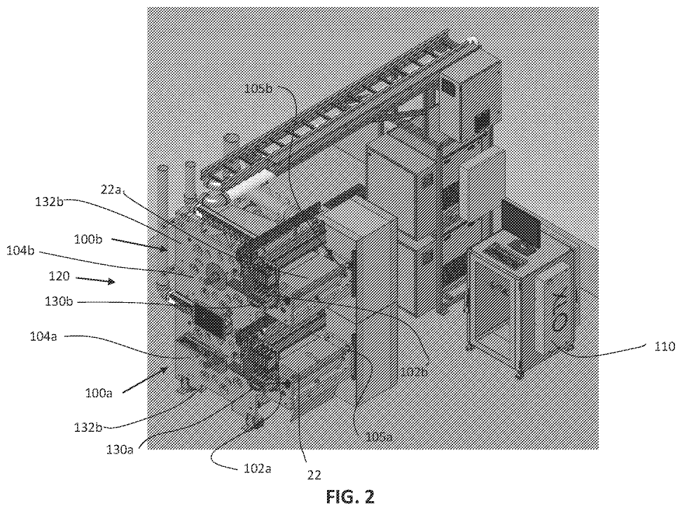

The embodiment of FIG. 2 utilizes two of the modules 100 together in a stacked configuration to form a printing system 120 operated by the global controller 110. More particularly, a first module 100a receives thereupon a second module 100b, wherein each module 100a and 100b is identical or substantially identical to the module 100 and the second module 100b is preferably secured atop the first module 100a. The substrate 22 is fed through infeed/outfeed handling apparatus 105a of the first module 100a and thereafter through infeed/outfeed handling apparatus 105b of the second module 100b. In an exemplary embodiment, printheads 102a of the first module 100a may print primary process colors C, M, Y, and K on one side 22a of the substrate 22 and the printed content is dried by a dryer unit 104a of the module 100a. Thereafter, printheads 102b of the second module 100b may print other colors, such as secondary process color inks orange, violet, and green (OVG) and an optional spot color ink S atop and/or in combination with the primary process colors on the same side 22a of the substrate 22 to effectuate simplex printing. The printed content may then be dried by a dryer unit 104b of the second module 100b and the substrate 22 may thereafter be passed to other modules, units, and/or devices as necessary or desirable. Alternatively, the first module 100a may apply a first material such as a primer, a coating, or print a panel, etc. and the applied material may be dried and thereafter the second module 100b may apply and dry a second material, such as at least one process or other “color,” (noted hereinafter) atop the first material, again to accomplish simplex printing.

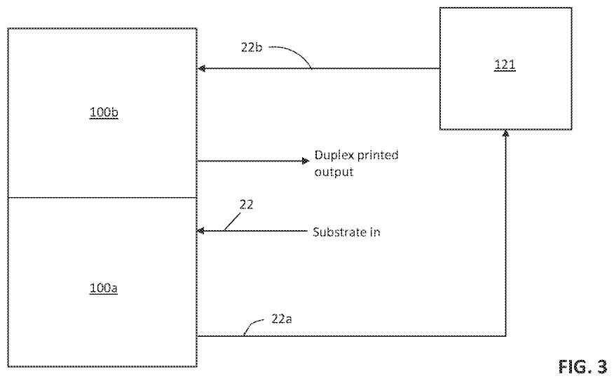

Referring also to FIG. 3, duplex printing using both modules 100a, 100b may be undertaken using, for example, an optional turn bar or other substrate inversion device(s) and possibly other apparatus, such as optional further roller(s), collectively generally shown at 121. The substrate 22 may be turned over between modules 100a, 100b, in which case the turn bar or other substrate inversion device(s) 121 (arranged in any desired order) is/are disposed downstream of the module 100a and upstream of the module 100b. In such an embodiment, one or more other rollers and/or other devices may be used to transport the substrate 22 to a location spaced from the modules 100a, 100b at which the turn bar or other substrate inversion device(s) 121 is/are disposed such that adequate room is provided to invert the substrate. Also in such embodiment, a first side 22a of the substrate 22 is printed by the printheads 102a of the module 100a and a second side 22b of the substrate 22 is printed by the printheads 102b of the module 100b. In such an embodiment, it may be advantageous and/or desirable that both of the printheads 102a and 102b print CMYK process colors or any other same or different color(s), either at the same resolution or different resolutions, as necessary or desirable.

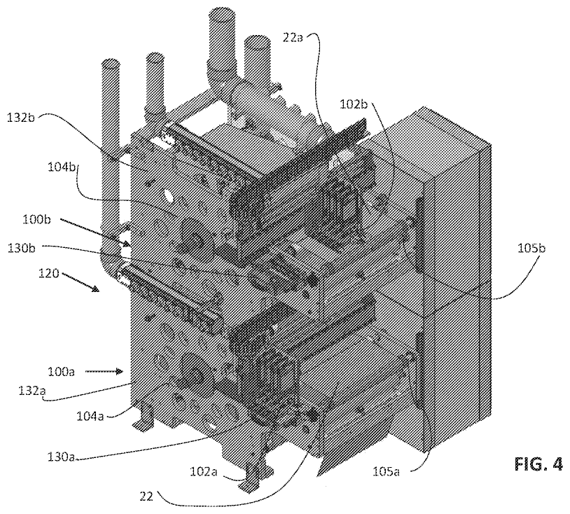

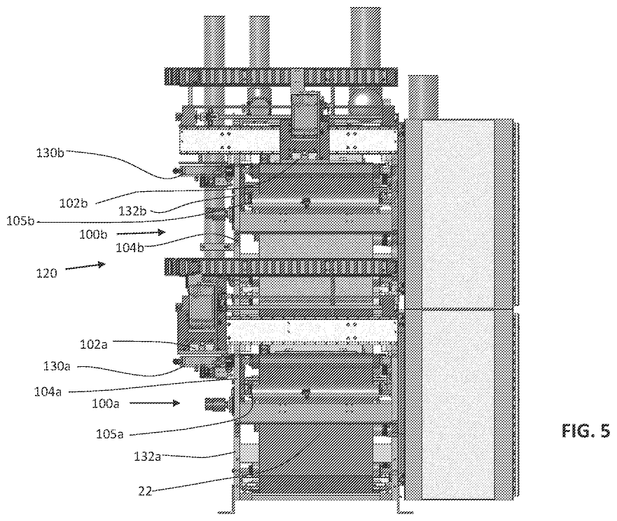

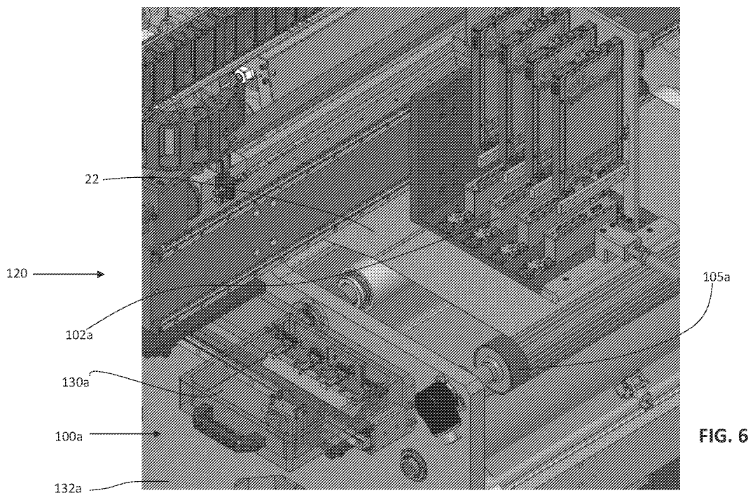

As in each of the other embodiments disclosed herein, the printheads 102a, 102b are slidably mounted for movement under control of the global controller 110 and the printhead transport apparatus 114 between an operational or printing position and a maintenance or cleaning position. FIG. 2 illustrates both printheads 102a, 102b disposed at cleaning positions opposite cleaning stations 130a, 130b disposed at one side of the transport apparatus 105a, 105b, respectively, whereas FIGS. 4 and 5 illustrate the printhead 102a at the cleaning position opposite the cleaning station 130a and the printhead 102b at the printing position opposite the substrate 22. The printhead 102a is disposed at the printing position in FIG. 6.

Each of the modules 100a and 100b includes a dryer system 104a, 104b comprising a plurality of dryers arranged around a transport drum. The dryers and transport drums are disposed within housings 132a, 132b, and are not visible in FIGS. 2-5. The dryers are controlled to dry the ink applied to the substrate 22 in a fashion to minimize deformation of the substrate as much as possible. Each dryer system 104a, 104b may be controlled by the global controller 110 similar or identical to the manner disclosed hereinafter in connection with the embodiment of the remaining FIGS.

The controller 110 is operable to control the modules 100a, 100b in a coordinated fashion to apply one or more inks to the substrate 22. In an embodiment, the registration module 316 described below is implemented by the controller 110 to cause the modules 100a, 100b to print in register in the fashion described below.

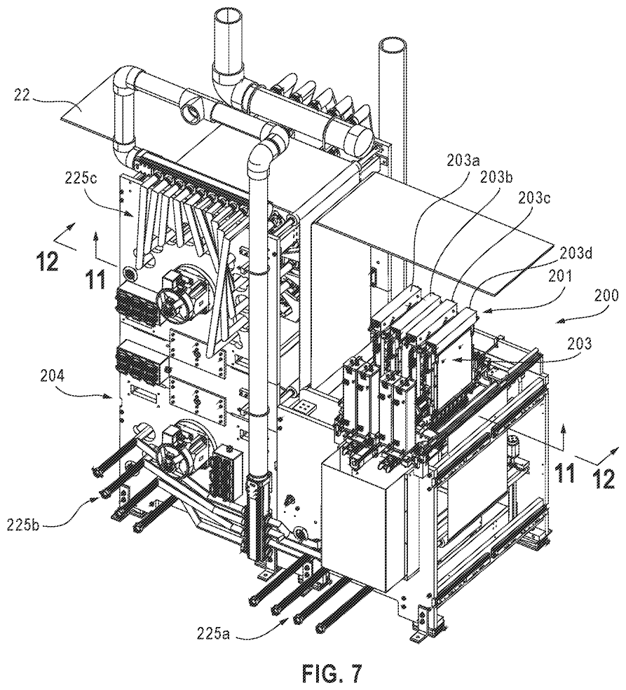

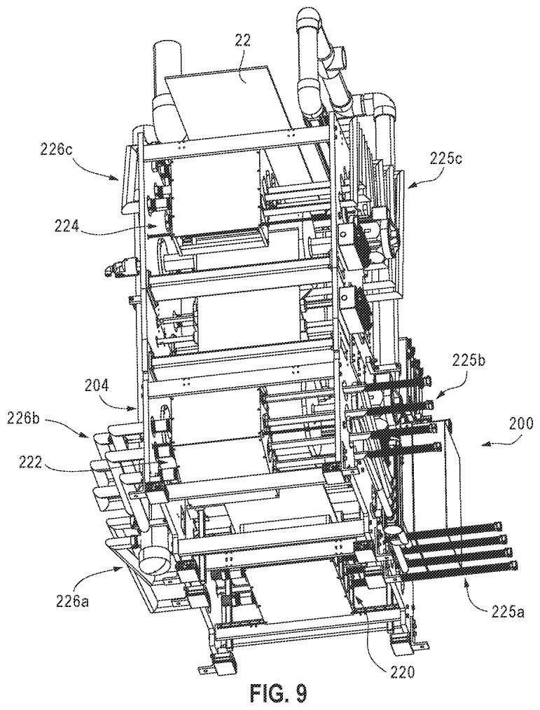

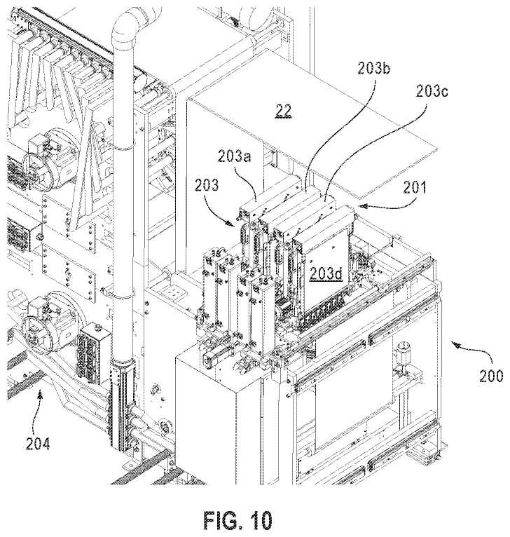

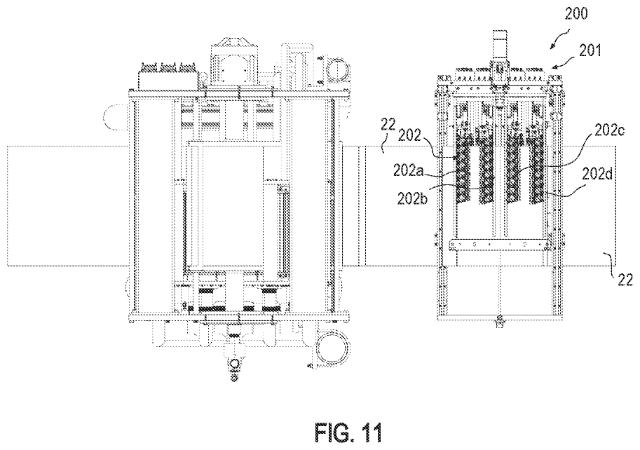

FIGS. 7-11, and 16 illustrate an embodiment of a module 200 responsive to the global controller 110, and, optionally, other devices, that prints aqueous substances on the flexible substrate 22. (It may be noted that FIGS. 7-12 are illustrated with certain tubing and fluid conduits omitted therefrom for the sake of clarity while FIG. 16 illustrates various components of the module 200 with fluid interconnections shown schematically therebetween). The module 200 includes one or more printing units 201 each comprising one or more ink jet printheads 202, (seen in detail in FIG. 11), with associated printhead controllers 203. In the illustrated embodiment, each of four controllers 203a-203d is associated with and operates one of four printheads 202a-202d, respectively. The module 200 further includes ink supply apparatus, such as one or more ink supply units 205 that receive ink from a main ink reservoir 205a shown in FIGS. 16 and 17, a dryer system 204 comprising one or more dryers (best seen in FIG. 12), and a substrate transport apparatus 212 that controls the continuous movement of the substrate 22 at a throughput speed of, for example, 500 feet per minute. The substrate may instead be transported at a faster or slower throughput speed, e.g., 1000 feet per minute, as desired. The global controller 110 is responsive to one or more sensors and controls the substrate transport apparatus 212, the ink supply unit(s) 205, the printheads 202 via the controllers 203, and the dryer system 204. The global controller 110 may also control additional elements and may be implemented by one or more suitably programmed computer-based devices, each comprising, e.g., a desktop or laptop computer, a device using one or more application specific integrated circuits (ASIC's) and/or field-programmable gate arrays (FPGA's), a tablet, a smartphone, etc. and/or combinations thereof. The global controller 110 may be unitary or may be distributed across one or more networks. As seen in FIG. 16, the global controller 110 is coupled to local and/or networked interfaces, such as a keyboard, a mouse, a display, a touchscreen, a local area network (LAN), a wide area network (WAN) such as the Internet, etc. The global controller 110 is responsive to commands supplied thereto by a user via the local and/or networked interfaces.

In addition to the foregoing, the module 200 includes one or more structural elements that provide support for various conduits and other elements and enclosures that provide spaces to house various elements, as necessary and/or desirable.

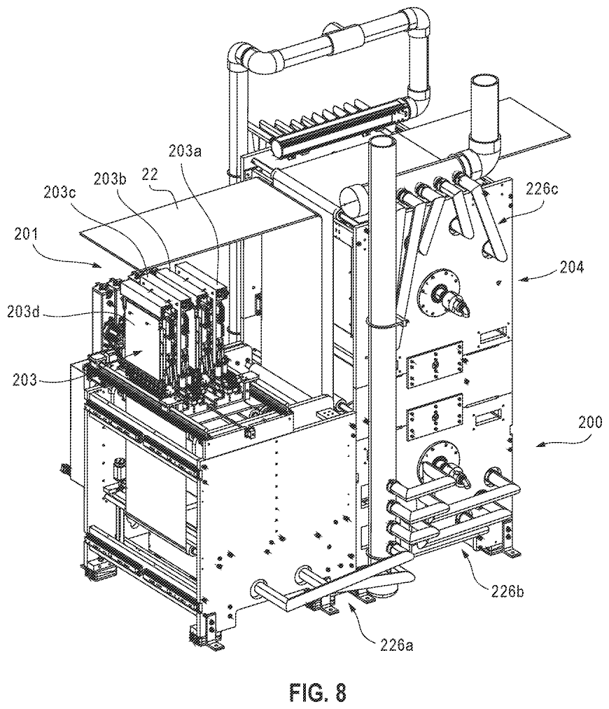

As seen specifically in FIG. 12, the dryer system 204 comprises first, second, and third sets of dryers 220, 222, and 224, respectively. The dryer sets 200, 222, and 224 include dryers 220a-220d and 222a-222d and 224a-224j, respectively, (FIG. 12) successively arranged in the FIGS. in sequence of substrate movement. Some or all of the dryers 220a-220d, 222a-222d, and/or 224a-224j may comprise one or more dryer components, such as heaters and/or blowers, or may simply comprise passive conduits or radiators, and may receive dryer air from inlet conduit sets 225a-225c (FIG. 7) and may exhaust air through exhaust conduit sets 226a-226c (FIG. 8). The dryer system 204 further comprises first and second rotatable drums 227 and 228 disposed opposite the sets 222 and 224, respectively. The drums 227, 228 control substrate tension. Further, rollers 230a-230g, some or all of which may comprise driven or idler rollers, are arranged as seen in FIG. 12 in successive manner in order of substrate movement through the dryer system 204.

The dryers are controlled to dry the ink applied to the substrate 22 in a fashion to minimize deformation of the substrate as much as possible.

The printing unit 201 is disposed at a print station 250 accessible by an operator. As seen in FIG. 12, the print station 250 includes one or more idler or driven rollers 230d-230f successively arranged in the FIG. in order of substrate movement that transport the substrate through the printing unit 201 opposite the printheads 202, which are operated to deposit aqueous ink onto a single side 22a of the substrate 22 so as to effectuate simplex printing.

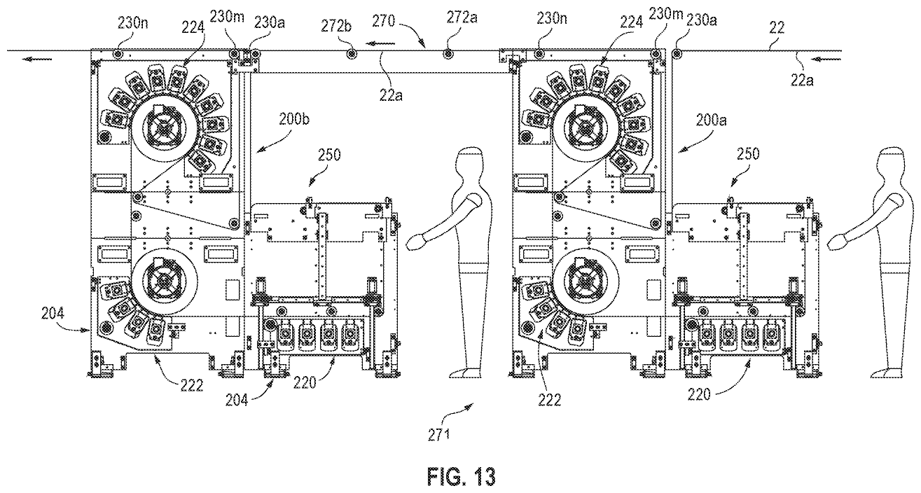

FIG. 13 illustrates an embodiment in which two of the modules 200 shown in FIG. 12 are disposed in a frame 270 that allows room for one or two operators to control the modules. (It may be noted that the frame 270 may form a part of or be associated with one or both of the modules or may be separate from both modules. Also, the printheads 202 and associated controllers are not shown in FIG. 13 and certain reference numbers for elements visible in both FIGS. 12 and 13 are not shown in FIG. 13 for clarity.) More specifically, first and second modules 200a, 200b, each identical to the module 200, are disposed in spaced relationship in the frame 270 to form a printing system 271. As should be evident from FIG. 13, the modules 200a, 200b print on the substrate 22 in serial fashion. The frame 270 includes one or more idler and/or driven rollers 272a, 272b that transport the substrate 22 through the frame 270 and between the modules 200a, 200b. In the illustrated embodiment, the rollers 272a and 272b are successively arranged in FIG. 13 in the direction of substrate movement. Thus, as seen in FIG. 13 and also referring to FIG. 12, the substrate enters the module 200a and passes over/about the rollers 230a-230c of the module 200a, and thereafter passes over the rollers 230d-230f in the print station 250 of the module 200a. In the process of traveling from the roller 230d to the roller 230f, the printheads 202 deposit aqueous ink on the side 22a of the substrate. The ink that is deposited may be any individual “color(s)” or combination(s) thereof, including C (cyan), M (magenta), Y (yellow), K (key, i.e., black), O (olive), V (violet), G (green), S (a spot color), white, a clear or other primer, UV (ultraviolet), a magnetic ink, etc. In an embodiment, the module 200a prints a clear primer and/or a white panel and other printed content on successive portions of the substrate 22 at 1200 dpi or any other resolution.

Following application of ink, the substrate 22 traverses the rollers 230g-230i of the module 200a and passes the first set of dryers 220 of such module. The printed side 22a of the substrate 22 is presented toward a first stage of the dryer system 204 comprising the dryers 220a-220d, which are operated as pinning devices and initiate the drying process. As seen in FIG. 12, the substrate 22 travels to the drum 227 and thereafter to the drum 228 via the roller 230j, and the substrate 22 is then guided by the rollers 230k-230n and out of the module 220a. As should be evident, the side 22a is sequentially presented to second and third stages of the dryer system 204 comprising the dryers 222a-222d and 224a-224k, respectively, to complete the drying process.

The substrate continues over the rollers 272a and 272b (FIG. 13) to the module 200b at which the side 22a of the substrate 22 receives further printed content as described above in connection with the module 200a. The printed content on the side 22a is dried as described above by a dryer unit 204 of the second module 200b. The printed substrate may be transported out of the frame 270 for further handling, printing, processing, and/or storage, as necessary or desirable.

In an embodiment, the module 200b of FIG. 13 prints up to four “colors” (as noted above) on the side 22a of the flexible substrate 22. Thus, for example, the module 200b may print, for example, C, M, Y, and/or K at a resolution of 1200 dpi or any other resolution in register with the successive portions of the substrate 22 that are printed by the module 200a. In a further example, the module 200a may print primary process colors C, M, Y, K at any resolution on successive portions of the substrate 22 and the module 200b may print secondary process colors O, V, G, and an optional spot color S in register with and atop and/or in combination with the primary process colors C, M, Y, K on the same side 22a of the substrate 22. Alternatively, in such an embodiment, it may be advantageous and/or desirable that both of the modules 200a, 200b print primary and/or secondary process colors or any other same or different “color(s)” either at the same resolution or different resolutions, in-register or out-of-register, as necessary or desirable.

If more “colors” and/or different resolutions are to be printed, additional printheads and associated printhead controllers and ink supplies can be added to the module(s) 200a, 200b. Alternatively, a turn bar other substrate inversion device (not shown) may be provided between the modules 200a, 200b and/or downstream of the module 200b of FIG. 13 and one or two or more additional modules identical to the module 200 could be provided downstream of the turn bar or other substrate inversion device to permit duplex mode printing in four or eight or more “colors” on a side 22b of the substrate 22.

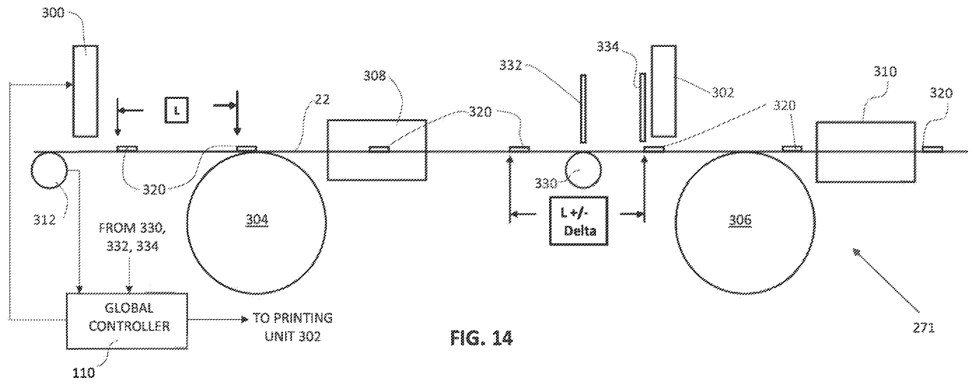

Referring to FIG. 14, a portion of a printing system, such as the system 271 of FIG. 13, is shown schematically and rearranged such that the direction of substrate movement is from left-to-right. The printing system portion includes first and second printing units 300 and 302, first and second handling apparatus represented by drums 304 and 306 and dryer systems and other processing apparatus 308 and 310, respectively. The elements 300, 304, 308 may comprise portions of the module 202a whereas the elements 302, 306, and 310 may comprise portions of the module 202b. The printing system elements, including the first and second printing units 300 and 302 and other apparatus, are operated, for example, by the global controller 110 of FIGS. 14 and 16. A first encoder roller 312, which may comprise a portion of the module 202a, detects movement of the substrate 22 as a number of raster lines at the resolution of the first printing unit 300. Thus, for example, the first printing unit 300 may operate at a resolution of 1200 dots per inch (dpi) and the encoder roller may develop a pulse every 1/1200 inch (i.e., 0.00083 inch) (0.021 mm) of substrate movement. Referring also to FIG. 17, a raster image processor (RIP) 314 of the global controller 110 develops bitmaps from page definition language (PDL) commands and converts the bitmaps to raster maps in accordance with the resolution at which the printing unit 300 is to be operated. Each raster map includes a plurality of lines (or sequences) of data values each associated with a corresponding raster line of the substrate. A registration module 316 of the global controller 110 is responsive to the raster maps and the output of the encoder roller 312 and further sensors described below to command printing by the printing units 300 and 302.

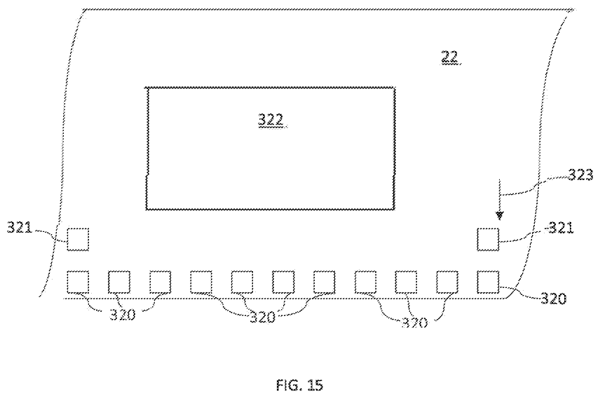

In an example, and as shown in FIG. 15, the first printing unit 300 comprises a 1200 dpi printer located at a first print process position that is commanded to print registration marks 320 and top of form marks 321 separate from the registration marks 320 together with a white panel 322 at proper positions on the substrate, as measured by the first encoder roller 312. The registration marks 320 and the top of form marks 321 do not overlap the white panel 322 and may be printed with a different ink, such as UV ink, if desired. The registration marks 320 are printed, for example, at equal distances on the substrate 22 (for example, at 1 inch or less spacings) while the top of form marks 321 are printed at the start of each successive substrate portion (also referred to as a page) e.g., every ten inches. A particular portion of each of the top of form marks 321, such as a leading edge, is preferably printed at a predetermined distance from the first raster where a leading edge of the white panel 322 is printed. Alternatively, the particular portion of each of the top of form marks may be printed at any other known locations of the substrate 22. Also, a leading edge of each of the top of form marks 321 preferably is printed at a position indicated by the arrow 323 collinear along the width dimension of the substrate with a leading edge of a registration mark 320. It may be noted that, in an embodiment, the registration marks 320 may be printed at equal spacings such that all or some of the registration marks 320 have a predetermined relationship relative to the first raster line (i.e., the raster line where a leading edge of the image is printed) so that the top of form marks 321 would not be needed. In any event, the printed marks 320, 321 and the white panel 322 are thereafter dried and the substrate 22 is otherwise processed and/or moved by or through the other apparatus 308.

During and/or after drying and other processing and substrate handling during movement the substrate 22 may stretch, shrink, or otherwise deform. As an example seen in FIG. 14, the substrate 22 may elongate such that the distance between successive registration marks 320 increases by 1% (i.e., if the spacing between successive registration marks 320 at the first print position is 1 inch, the spacing between the same successive registration marks 320 at a second print process position at which the second printing unit 302 is located downstream of the first print process position is be 1.01 inches). The changed distance between registration marks 320 following the drying and other processing/handling by the drum 304 and dryer systems and other processing apparatus 308 is sensed by a second encoder roller 330 and a first optical sensor 332, which together may comprise a portion of the module 202b. The second encoder roller 330 develops a raster pulse each time the substrate 22 moves a distance equal to a distance between adjacent raster lines at the resolution of the second printing unit 302. Thus, for example, if the second printing unit 302 operates at a resolution of 600 dpi, the second encoder roller develops a pulse each time the substrate 22 moves 1/600th of an inch (i.e., 0.00167 inch or 0.042 mm), which corresponds to the distance between successive raster lines at 600 dpi. The first optical sensor 332 develops a pulse at an output thereof each time a particular portion (e.g., a leading edge) of a registration mark 320 is detected thereby.

Preferably the second encoder roller 330 and the first optical sensor 332 are co-located upstream of the second printing unit 302 by a selected distance along the process direction, such as 18 inches. The distance is far enough to provide adequate room for system components, but not so far that deformation is likely to occur as the substrate 22 passes through such distance.

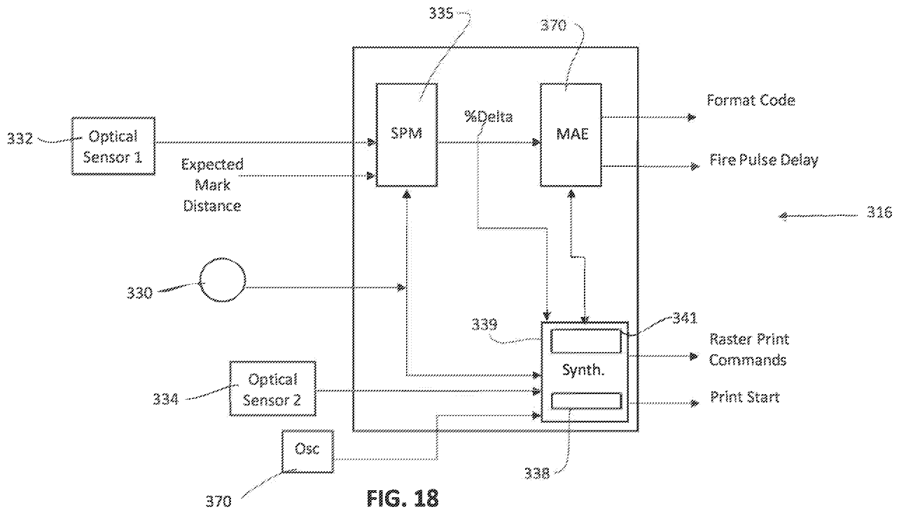

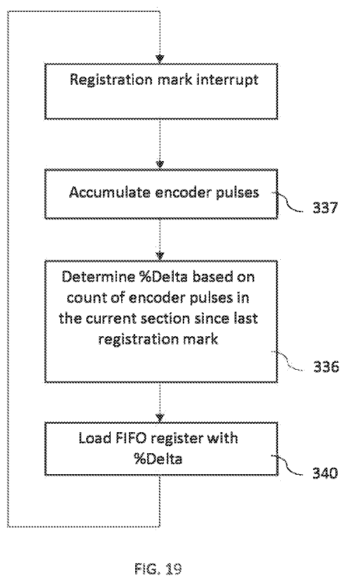

Referring also to FIG. 18, which illustrates a portion of the global controller 110 forming the registration module 316, the second encoder roller 330 and the first optical sensor 332 are coupled to a detector in the form of a “Sync Percent” module (referred to hereinafter as “SPM”) 335 of the global controller 110. Referring also to FIG. 12, each time the first optical sensor 332 develops a pulse, an interrupt is developed by the SPM 335. As each interrupt is developed, the SPM 335 calculates a current value of a parameter % Delta at a block 336 according to the following equation:

$$\% Delta = ( ( Count ) ( RD ) - E ) / E$$

where Count is the number of raster pulses that have been received by the SPM 335 from the second encoder roller 330 since the last interrupt was developed as accumulated by a block 337, RD is the distance (along the process direction) between successive (i.e., adjacent) raster lines at the resolution of the second printing unit 302, and E is the distance between corresponding portions (e.g., the leading edges) of successive registration marks as printed at the first printing unit (equivalently, E represents the expected distance between corresponding portions of successive registration marks at the first optical sensor 332 assuming no deformation of the substrate 22). Thus, the second encoder roller 330, the first optical sensor 332, and the global controller 110 via the SPM 335 count the number of raster pulses between corresponding portions of each pair of successive registration marks to obtain a raster count, convert each raster count to a measured registration mark separation distance based on an indication of the resolution of the counted raster pulses, and compare the measured registration mark separation distance to the expected distance between successive registration marks (i.e., the distance that would have been measured had no deformation occurred, e.g., 1 inch) to update the parameter % Delta. The continually updated values of % Delta are stored in a first-in first-out (FIFO) register 338 of a synthesizer 339 (both seen in FIG. 18) by a block 340 of FIG. 19 and are used as noted below to adjust the print commands that cause ink to be deposited in response to a particular line of the raster map stored in a memory 341 of the global controller 110 for all but the first raster line that corresponds to the leading edge of the printed image. While the memory 341 is illustrated as comprising a part of the synthesizer 339, the memory 341 may form a part of any portion of the global controller 110 or may be separate from the global controller 110, as desired. In an embodiment, the FIFO register 338 is indexed at a particular time delay following each time the that the first optical sensor 332 develops a pulse when a leading edge of a registration mark is sensed. This time delay, which may be measured as the time required for the second encoder roller 330 to develop a particular number of raster pulses, accounts for the time required for the substrate 22 to traverse the distance between the first optical sensor 332 and the printheads of the second printing unit 302.

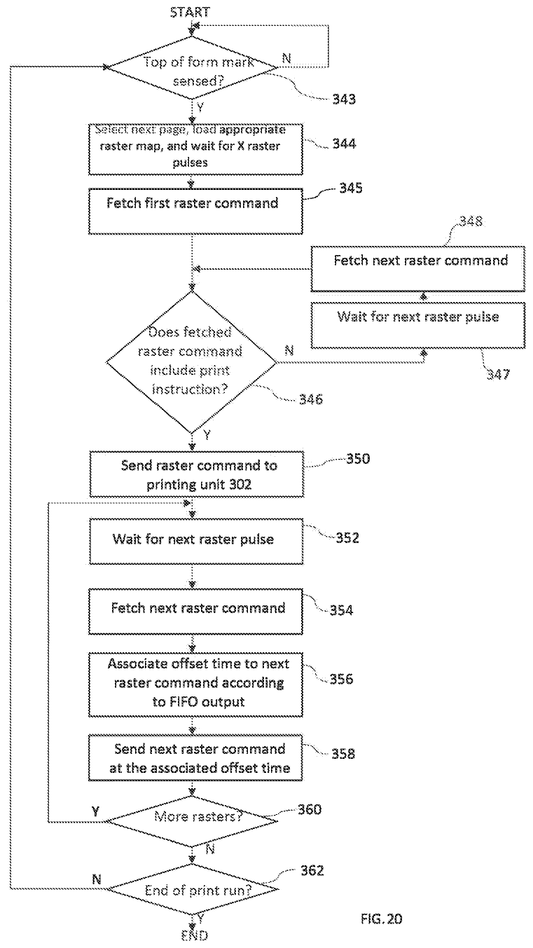

The synthesizer 339 is responsive to the output of the second optical sensor 334 that detects the leading edge (or some other portion) of each top of form mark 321. As seen in FIG. 14, the second optical sensor 334 is preferably located as close as practicable to the second printing unit 302. In an embodiment shown in FIG. 20, when a top of form mark 321 is sensed by a block 343, control passes to a block 344, which selects the next page to be printed, optionally loads the corresponding raster map in a buffer or other memory, and waits until a number X of raster pulses have been developed by the second encoder roller 330 to account for the distance that must be traveled by the substrate 22 between the second optical sensor 334 and the second printing unit 302. Thereafter, a block 345 fetches a first raster command of the raster map stored in the buffer and a block 346 determines whether the first raster command includes an instruction to deposit ink on a corresponding first raster of the substrate 22. In this regard, drops of ink may or may not be actually deposited at the first raster line position depending upon the raster map stored in the buffer. If no drops of ink are to be printed at this first raster line position (and, in fact, at any other subsequent raster line positions) null commands or no commands may be issued to the printhead controllers at the appropriate time(s) (FIG. 20 illustrates both possibilities). Accordingly, if no ink is to be applied onto the corresponding substrate raster, control pauses at a block 347 until the next raster pulse is developed by the second encoder roller 330, whereupon a block 348 fetches a next raster command from the buffer and control returns to the block 346. In this example, no raster command is issued to the printhead controllers when the raster command does not include a print instruction. Control remains with the blocks 346-348 until the block 346 determines that a raster command includes a print instruction. Upon such determination, a block 350 sends the raster command to the printing unit 302 for printing of the raster and control thereafter pauses at a block 352 until the next raster pulse is developed by the second encoder roller 330.

Following the block 352, a block 354 fetches the next raster command of the raster map stored in the buffer. A block 356 applies a timing offset that is associated with the raster command in accordance with the value of % Delta that is then present at the output of the FIFO register 338. The raster command is sent to the printhead controllers of the second printing unit 302 by a block 358 at an associated offset time that causes the printheads of the second printing unit 302 to deposit drops of ink associated with a next line of the raster map on an offset next raster line of the substrate (i.e., provided that the raster command includes a print instruction). This offset has a nonzero magnitude if the substrate 22 has deformed and a zero magnitude if no deformation has occurred. A block 360 then checks to determine if there are more raster commands to be processed. If so, control returns to the block 352. Otherwise, a block 362 checks to determine whether an end of the current print run has been reached. If so, the print run is terminated. If not, control pauses until the next top of form mark is sensed, whereupon the process repeats.

In summary, the registration module 316 causes the first printed raster of each page to have no registration offset, and each subsequent raster of the substrate to have registration offset (which may be positive, negative, or zero depending upon stretching, shrinking, or no deformation, respectively, of the substrate 22) based on an associated value of % Delta. In this regard, the timing offset is constant for all substrate rasters in a raster section extending along the process direction disposed between an associated two successive registration marks. Also, the FIFO indexing is synchronized to the movement of the substrate 22 so that the values of % Delta are provided at the output of the FIFO register 338 in a coordinated manner to the transmission of raster commands to the second printing unit 302. The registration module 316 thus causes the printheads of the second printing unit 302 to print each raster of content atop or in positional association with a corresponding raster printed by the first printing unit 300 so that printing within a selected or desired degree of registration with the content printed by the first printing unit 300 is accomplished. The registration module 316 is effective to correct registration errors up to approximately 1%. For registration errors greater than approximately 1% the timings of the printheads may require adjustment in the manner described below to bring the registration error to or below 1%, whereupon the registration module 316 can correct for any remaining registration error. Registration error can be further reduced by shortening the distance between adjacent registration marks.

The synthesizer is responsive to an oscillator 370, which may develop an oscillator signal at 20 Mhz. or any other suitable frequency, and the possible substrate raster positions along the process direction are divided in accordance with the frequency of the oscillator signal into small portions (equivalent to timings, such as 50 nsec.) to define the resolution of the registration correction. If necessary or desirable, a command to print a raster at a location defined by the oscillator 370 may be ignored and no raster may be printed at such location to increase the distance between successive printed rasters to compensate for stretch of the substrate. Alternatively, one or more rasters may additionally be printed beyond those corresponding to rasters defined by the raster map at one or more of the 50 nsec. timings wherein these additional printed rasters are synthesized (i.e., derived) from data in the raster map to compensate for shrinkage or other deformation.

As seen in FIG. 18, the % Delta parameter is also supplied to a Micro Adjust Encoder (MAE) 370 that adjusts the firing of nozzles in the printheads of the second printing unit so as to, at least potentially, further increase the degree of registration correction realized by the synthesizer 339. The MAE 370 develops “Format Code” and “Fire Pulse Delay” signals specific to the brand of printheads that are used in the second printing unit 302. In example embodiments, printheads sold by Fujifilm Dimatix, Inc. of Santa Clara, California, as models Samba G3L and/or Samba G5L or printheads sold by Kyocera Corporation of Kyoto, Japan, as part no. KJ4B-YH06WST-SL1V may be used, for example, in the second printing unit 302. Each Fujifilm Dimatix Samba printhead has 2 groups of nozzles arranged in 2 segments, while each Kyocera head includes 16 segments. The Format Code and Fire Pulse Delay signals allow operation of each of the printheads at a resolution that is different than the grid determined by the native resolution of the head. For example, the “Format Code” and “Fire Pulse Delay” signals can instruct the printheads to operate a 1200 dpi head to print on a grid associated with 1080 dpi to compensate for a 10% stretch in the substrate. As noted herein, if necessary or desirable, one or more further data processing steps as described herein can be undertaken to implement position and/or scale adjustments to the raster data to further improve registration during printing. As is apparent to one of ordinary skill in the art, all of the nozzles in a segment must be fired simultaneously but the delay between firing one segment and another can be adjusted using the “Fire Pulse Delay” signal. The “Format Code” may be used to determine the order in which segments are fired. The firing control of the heads will vary with the heads that are used.

The registration functions may also be derived from one set marks, either once or multiple per image in the web direction. The benefit of the multiple marks per image is that updates to the scale factor can be more frequent. With one set of marks, a periodic mark could be unique from others in the same set to identify the TOF (top of form). One way to make it unique would be to change its length along the web. The benefit of one set of marks is fewer sensors, reduced receiving hardware and cables, less print area consumed in the product, less printhead wear, and less ink used

The registration methodology described above can be extended to more than two printing units, as should be evident to one of ordinary skill in the art.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### INDUSTRIAL APPLICABILITY

The registration apparatus and process disclosed herein senses a degree or magnitude of distortion in a substrate and adjusts the effective resolution of a downstream printer to achieve registration at least to a desired degree. In an embodiment, the distortion is continually sensed and updated values of the distortion are used to apply registration offsets to raster commands, except a first raster command containing a print instruction following a top of form mark, to control one or more downstream printers so that raster lines are printed with offsets that remain constant until a next distortion magnitude is determined, whereupon the raster line registration offset is updated and applied. Registration is thereby effectuated on the fly on a section-by-section basis within printed content (e.g., a single image) as the printing unit is operating. The size of each section printed with a constant offset can be made as small as computing power permits, thereby providing a flexible and configurable system and method.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the embodiments (especially in the context of the following claims) are to be construed to cover both the singular and the plural, unless otherwise indicated herein or clearly contradicted by context. Recitation of ranges of values (i.e. amounts) herein are merely intended to serve as a shorthand method of referring individually to each separate value falling within the range, unless otherwise indicated herein, and each separate value is incorporated into the specification as if it were individually recited herein. In a case in which a constituent comprises multiple components, selection of one or more amount(s) of one or more components of the constituent may result in the necessity/desirability to limit the amount(s) of one or more remaining component(s) of the constituent while keeping each such remaining component amount within a portion of its specified component range so that the percentage by weight of the constituent in the overall printing composition falls within the specified constituent range. Similarly, selection of one or more amounts of one or more constituents may result in the necessity/desirability to limit the amount(s) of one or more other constituent(s) each to a value within a portion of its associated specified range. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure. Unless otherwise noted, all recitations of weight percentages are with reference to a unit weight of the printing composition as a whole.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A printing system for printing on a flexible substrate movable in a downstream process direction, comprising:
a first ink jet printing unit that prints on the substrate a first plurality of spaced registration marks, a second plurality of raster lines between a first successive pair of registration marks, and a third plurality of raster lines between a second successive pair of registration marks that are adjacent the first pair of successive registration marks wherein the first plurality of raster lines and the second plurality of raster lines together comprise a single image;
a detector downstream of the first printing unit that
detects the first successive pair of registration marks,
calculates a first magnitude of distortion of the substrate based on the detection of the first successive pair of registration marks,
detects the second successive pair of registration marks, and
calculates a second magnitude of distortion of the substrate based on the detection of the second successive pair of registration marks; and
a second ink jet printing unit responsive to and downstream of the detector that prints on the substrate a fourth plurality of raster lines between the first successive pair of registration marks at positions relative to the second plurality of raster lines dependent upon the first magnitude of distortion, and a fifth plurality of raster lines between the second successive pair of registration marks at positions relative to the third plurality of raster lines dependent upon the second magnitude of distortion.

2. The printing system of claim 1, wherein the detector is responsive to an encoder roller that detects movement of the substrate and an optical detector that detects the registration marks.

3. The printing system of claim 2, wherein the second ink jet printing unit is capable of printing raster lines at a resolution, the detector accumulates raster pulses developed by the encoder roller, the optical detector develops an interrupt each time a registration mark is sensed, and the detector calculates a current value of a parameter % Delta according to the equation:
$$\% Delta = ( ( Count ) ( RD ) - E ) / E$$
where Count is the number of raster pulses that have been accumulated by the detector between development of a first interrupt by the optical detector and development of a next interrupt by the optical detector, RD is the distance along the process direction between successive raster lines at the resolution of the second printing unit, and E is the distance between corresponding portions of successive registration marks as printed at the first printing unit.

4. The printing system of claim 1, wherein the detector comprises a portion of a controller that controls the first printing unit and the second printing unit.

5. The printing system of claim 4, wherein the controller includes a memory that stores a raster map for the second printing unit.

6. The printing system of claim 5, wherein the controller comprises a first-in first-out register that stores values representing distortion of the substrate.

7. The printing system of claim 4, wherein the first ink jet printing unit further prints top of form marks on the substrate and the controller comprises a further optical sensor operative to sense the top of form marks and means for transmitting a first raster print command without any registration offset to the second printing unit.

8. A method of ink jet printing on a flexible substrate movable in a downstream process direction, the method comprising the steps of
undertaking a first printing process on the substrate at a first print process position to print a first plurality of spaced registration marks, a second plurality of raster lines between a first successive pair of registration marks, and a third plurality of raster lines between a second successive pair of registration marks that are adjacent the first pair of successive registration marks wherein the first plurality of raster lines and the second plurality of raster lines together comprise a single image;
detecting the first successive pair of registration marks;
calculating a first magnitude of distortion of the substrate based on the detection of the first successive pair of registration marks;
detecting the second successive pair of registration marks;
calculating a second magnitude of distortion of the substrate based on the detection of the second successive pair of registration marks;
undertaking a second printing process on the substrate at a second print process position downstream of the first print process position to print a fourth plurality of raster lines between the first successive pair of registration marks at positions relative to the second plurality of raster lines dependent upon the first magnitude of distortion; and
undertaking a third printing process on the substrate to print a fifth plurality of raster lines between the second successive pair of registration marks at positions relative to the third plurality of raster lines dependent upon the second magnitude of distortion.

9. The method of claim 8, wherein each of the detecting steps comprises the steps of accumulating raster pulses developed by an encoder roller that detects movement of the substrate and sensing an output of an optical detector that detects the registration marks.

10. The method of claim 9, wherein the second printing process comprises the step of printing raster lines at a particular resolution, and further including the steps of using a detector to accumulate raster pulses developed by the encoder roller, causing the optical detector to develop an interrupt each time a registration mark is sensed, and causing the detector to calculate a current value of a parameter % Delta according to the equation:
% Delta=((Count)(RD)−E)/E
where Count is the number of raster pulses that have been accumulated by the detector between development of a first interrupt by the optical detector and development of a next interrupt by the optical detector, RD is the distance along the process direction between successive raster lines at the particular resolution, and E is the distance between corresponding portions of successive registration marks.

11. The method of claim 10, wherein the detector comprises a portion of a controller and including the step of causing the controller to control the steps of undertaking the first printing process and undertaking the second printing process.

12. The method of claim 11, wherein the step of undertaking the second printing process further includes the step of causing the controller to store a raster map in a memory.

13. The method of claim 12, further including the step of causing the controller to store values representing distortion of the substrate a first-in first-out register.

14. The method of claim 9, wherein the step of undertaking the first print process further including the step of c printing top of form marks on the substrate, and further including the steps of causing a further optical sensor to sense the top of form marks, and causing a controller to transmit a first raster print command without any registration offset for use by the second printing process.

15. A printing system for printing on a flexible substrate movable in a downstream process direction, comprising:
a first ink jet printing module that prints a first material on the substrate;
a second ink jet printing module stacked atop the first module that prints a second material on the substrate; and
a controller operable to cause the first and second ink jet modules to print in a coordinated fashion.

16. The printing system of claim 15, wherein the first ink jet printing module and the second ink jet printing module print on a same side of the flexible substrate.

17. The printing system of claim 15, wherein the first ink jet printing module and the second ink jet printing module print on opposite sides of the flexible substrate.

18. The printing system of claim 15, wherein the controller is operable to cause the first and second ink jet modules to print in register.

19. The printing system of claim 15, wherein each of the first and second ink jet modules includes infeed and outfeed handling apparatus wherein the outfeed handling apparatus of the first ink jet module supplies the substrate to the infeed handling apparatus of the second ink jet module.

20. The printing system of claim 19, wherein each of the first and second ink jet modules includes a dryer system disposed upstream of the outfeed handling apparatus.
